(19) United States
(12) Patent Application Publication
(10) Pub. No.: US 2009/0218023 A1
(43) Pub. Date: Sep. 3, 2009

(54) Method for Controlling the Pressure in a Wheel for Vehicles and Wheel Having Controlled Pressure According to Said Method

(76) Inventor: Pier Giuseppe Piantanida, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/223,334

(22) PCT Filed: Feb. 28, 2006
(86) PCT No.: PCT/IT2006/000115

§ 371 Date: Dec. 8, 2008

(51) Int. Cl. B60C 23/00

(52) U.S. Cl. 152/418; 152/427

(57) ABSTRACT

A wheel having a controlled and compensated pressure includes: a rim associated with a tank adapted to be filled with a fluid to a first pressure; a tyre mounted on the rim and having an inner volume inflated to an operating pressure, the operating pressure being lower than the first pressure; at least one primary valve adapted to regulate communication between the tank and the inner volume of the tyre; the primary valve including at least one elastic element operatively associated with a closure member designed to open and close a port of the primary valve to bring the tank into communication with the tyre, when the pressure of the tyre is lower than the operating pressure, the elastic element having an elastic constant showing a variation of 10% to 40% within a temperature range between about −50° C. and about 50° C. A one-way valve hinders the fluid from flowing back from the tyre to the tank in the absence of pressure within the tank.

The present invention relates to a method of controlling the pressure in a vehicle wheel. The invention also relates to a wheel having a controlled and compensated pressure, to be used for putting said method into practice.

A wheel for two-wheeled or four-wheeled vehicles generally comprises a rim coupled with a tyre that is inflated to a given operating pressure.

Said tyre generally comprises a carcass structure having at least one carcass ply, and at least one annular reinforcing structure associated with the carcass ply, a tread band of elastomer material at a radially external position to the carcass structure, a belt structure interposed between the carcass structure and tread band and a pair of sidewalls at axially opposite positions on the carcass structure.

In tubeless tyres, the tyre airtightness is ensured by the radially inner layer of said carcass structure generally called “liner”. When in use, due to the natural air loss through said radially inner layer (which layer at all events is never perfectly impervious to air), pressure within the tyre decreases thereby obliging the vehicle driver to carry out periodical restoration of same.

In an attempt to make the tyre pressure substantially constant over a rather long period of time, it was suggested use of rims internally housing a tank for gas under pressure at a higher pressure than the operating pressure of the tyre. By one or more valves suitably operated, pressure is restored when required.

U.S. Pat. No. 6,601,625 B2 discloses a wheel with a compressed air tank integrated into the rim. More specifically it is disclosed a high pressure tank to store compressed air from an outer source, a first mechanical valve allowing the compressed air to flow from a source external to the high pressure tank, a second mechanical valve allowing air passage from the high pressure tank to the inner tube of the tyre, a third valve releasing air from the inner tube of the tyre, and a fourth valve releasing air from the high pressure tank. The wheel described in said patent keeps the tyre pressure within a predetermined value in a mechanical manner, reducing the necessity for the vehicle driver to manually inflate the tyre to reach the desired pressure. When pressure within the tyre decreases under a predetermined threshold value, the air stored in the high pressure tank is released into the tyre maintaining the latter inflated to the desired minimum pressure; on the contrary, when pressure in the tyre increases beyond a predetermined threshold value, the air is released from the tyre to the surrounding atmosphere.

U.S. Pat. No. 4,067,376 depicts a system for automatic re-admission of the air lost from a tyre while the vehicle is running in order to minimise the effects of an explosion. The wheel is formed with an integrated annular bag adapted to store an amount of compressed air under high pressure. A pressure safety valve is placed between said bag and the tyre and is adapted to release air from the bag to the tyre each time pressure within the tyre decreases below a predetermined limit.

WO 2005/084967 in the name of the same Applicant proposes insertion of a valve between a tank of fluid under pressure associated with the rim of a wheel and the tyre mounted on said rim, which valve is designed to compensate for pressure variations with respect to variations in the room temperature by an elastic element having a variable elastic constant in response to temperature variations, so as to keep the valve to a closed position when the inner pressure of the tyre decreases due to a temperature reduction. In this way, restoration of the operating pressure in the tyre is carried out only when the pressure has gone down as a result of true air losses (micropunctures, lack of airtightness of the liner, etc.) and not for reasons connected with lowering of the room temperature. Thus pressure in the tyre is maintained constant over long periods of time, due to the fact that the operating duration of the tank of fluid under pressure is increased, the other conditions being the same.

With reference to the known devices described above, the Applicant has however perceived that in the absence of pressure in the tank, i.e. should pressure within the tank be the same as the atmospheric pressure, opening of the valve for restoration of the operating pressure would give rise, instead of the desired flowing of fluid from the tank to the tyre, to a sudden transfer of the fluid still present in the tyre itself towards the tank, which will result in an immediate deflation of the tyre.

The Applicant has found that this circumstance can be a source of danger, should a pressure loss accidentally occur in the tank, for example following breakage of same. In fact the tyre could suddenly become deflated, even while running to a high speed.

The Applicant has ascertained that by providing between the tank of the fluid under pressure and the tyre, a safety valve which is able to intercept the fluid outflow towards the tank without inhibiting passage of fluid from the tank itself to the tyre, a sudden deflation of the tyre is avoided in case of fluid losses in the tank, the functional operation of the tank itself being maintained for purposes of maintenance of the operating pressure in the tyre.

More particularly, in a first aspect, the invention relates to a method of controlling pressure in a vehicle wheel, in which said wheel comprises a tyre mounted on a rim, said method comprising the steps of: inflating an inner volume of the tyre to an operating pressure; admitting a fluid compressed to a first pressure higher that the operating pressure of the tyre, into a tank associated with the rim; opening a fluid communication, by at least one primary mechanical valve, between the inner volume of said tyre and said tank when pressure of the inner volume of said tyre is lower than said operating pressure; stopping the communication between said inner volume and tank when said tyre pressure is substantially equal to said operating pressure; stopping the communication between said inner volume and tank when during said opening step by means of the primary valve, the pressure value within the tank is lower than the pressure value in the tyre.

Thus there is a guarantee that in case of breakage of the tank, or also in the absence of pressure for any other reason, opening of the valve adapted to cause flowing of fluid to the tyre does not cause flowing back of the fluid itself towards the tank, which would bring about deflation of the tyre.

Stopping of the fluid communication in case of weak pressure in the tank is preferably carried out by a mechanical safety valve, preferably a one-way on-off valve. Advantageously, the safety valve operates independently of the primary valve, thus avoiding undesirable structural complications in the primary valve itself and ensuring a satisfactory accuracy of intervention of said primary valve for restoration of the operating pressure of the tyre during normal running.

Opening of the fluid communication between the inner volume of the tyre and the tank can be advantageously carried out by at least one primary mechanical valve opening of which is controlled by an elastic element with an elastic constant varying in a temperature range from −50° C. to +50° C. so as to maintain said primary valve to a closed position following a reduction in the inner tyre pressure due to a temperature reduction within said range.

In a preferred embodiment of said method, said elastic element controlling opening of said primary valve has a value of elastic constant measured at −50° C. (K^{-50° C.}) differing from the value of elastic constant measured at +50° C. (K^{+50° C.}) by at least 10% with respect to the value of elastic constant measured at +50° C. (K^{+50° C.}).

In a different embodiment, said elastic element controlling opening of said primary valve has a value of elastic constant measured at −50° C. (K^{-50° C.}) differing from the value of elastic constant measured at +50° C. (K^{+50° C.}) by no more than 40% with respect to the value of elastic constant measured at +50° C. (K^{+50° C.}).

Advantageously, in order to obtain wide time gaps between two manual reloading operations in succession, the ratio between said operating pressure of the tyre and said first pressure in said tank is included between about 0.1 and about 0.6.

By optimising the available volumes, in a further embodiment, the ratio between said operating pressure of the tyre and said first pressure in said tank is included between about 0.2 and about 0.4.

Advantageously, said method allows widely spread reloading devices to be used, due to the fact that said first pressure in said tank is included between about 8 and about 12 bars.

In a different preferred embodiment said first pressure in said tank is included between about 8.5 and about 10 bars.

To enable a precise maintenance of the operating pressure within the tyre, also in the presence of pressure variations within the tank also resulting from progressive consumption of the fluid stored therein, opening of the fluid communication between tyre and tank is advantageously carried out in response to a pressure gradient reduction between the tyre pressure and the ambient pressure.

To improve the steadiness of the wheel system, said step of bringing the inner volume of said tyre into communication with said tank takes place when the pressure of the inner volume of said tyre is lower than said operating pressure by at least 5%.

In a further aspect, the invention relates to a wheel having a controlled and compensated pressure, comprising: a rim associated with a tank adapted to be filled with a fluid to a first pressure; a tyre mounted on said rim and having an inner volume inflatable to an operating pressure, said operating pressure being lower than said first pressure; at least one primary mechanical valve adapted to regulate a communication between said tank and the inner volume of said tyre, to bring said tank into communication with said tyre, when the pressure of said tyre is lower than said operating pressure; at least one safety valve operatively interposed between the inner volume of the tyre and the tank to stop the communication between said inner volume and tank when the pressure value within the tank is lower than the pressure value of the tyre.

In more detail, said safety valve can be a mechanical valve, preferably a one-way on-off valve.

The safety valve preferably comprises a second closure member to be made in the form of an elastic diaphragm or a ball acting against an abutment seat defined by a perimetral edge of a communication opening between the tank and the inner tyre volume.

A second auxiliary elastic element can be advantageously associated with the safety valve to push said closure member towards the perimetral edge of said communication opening, so as to maintain the safety valve in a closed condition.

Said safety valve can be advantageously integrated into a valve body of said primary valve so as to be integrated with the latter in a compact assembly of reduced bulkiness capable of facilitating housing of same in the wheel rim.

In a preferred embodiment of the invention, the primary valve comprises at least one elastic element operatively associated with a closure member designed to open and close a port of said primary valve. Said elastic element preferably has an elastic constant (K) varying in a temperature range from −50° C. to +50° C. for example, so as to maintain the primary valve to a closed position following a reduction in the inner tyre pressure due to a temperature reduction within said range.

In a further embodiment, to divide the available volumes in an optimal manner, said tank provides for such a volume that the ratio of said volume of said tank to said inner volume of the tyre is included between about 0.1 and about 0.4.

In a different embodiment, said ratio is included between about 0.12 and about 0.25.

In a preferred embodiment, said elastic element comprises at least one spring.

In another preferred embodiment, said elastic element comprises a second spring operatively associated with said one spring.

In a different embodiment, said second spring has an elastic constant (K) that is substantially constant within a temperature range from −50° C. to +50° C.

Thus more accuracy can be obtained in the possibility of modulating intervention of said primary valve in response to temperature variations. Modulation of the intervention, in fact, can specifically rely on the spring, in which materials and expedients are capable of favouring a variation of the elastic constant against the temperature, while the thrust function relies on the second spring with an elastic constant that is substantially insensitive to temperature variations.

In a preferred embodiment, said second spring supports a major portion of the load of said elastic element.

Preferably, the load supported by the second spring is included between about 60% and about 95% of the load supported by said elastic element.

More preferably, the load supported by the second spring is included between about 70% and about 80% of the load supported by said elastic element.

In another embodiment the second spring is concentrically coupled with said one spring.

In a preferred embodiment the second spring is external with respect to said one spring.

To enable an embodiment in which a thrust spring is provided, said elastic constant (K) decreases on decreasing of the temperature in said temperature range.

To obtain an embodiment in which a pulling spring is provided, said elastic constant (K) increases on decreasing of the temperature in said temperature range.

To enable restoration of the inflating pressure in the tyre to take place in a correct manner without being affected by pressure variations in the tank, the primary closure member preferably comprises a diaphragm having a first surface exposed to the pressure of the inner tyre volume, and a second surface exposed to the ambient pressure, or other reference pressure in an environment hermetically insulated from the tank.

More particularly, the primary closure member is movable relative to the primary-valve port in response to a reduction in a pressure gradient between the tyre pressure and the reference pressure.

In a preferred embodiment, said wheel comprises an inflating valve operatively associated with said tank.

In a different embodiment, said wheel comprises a control and restoration valve associated with said tyre.

In a different aspect, the invention also relates to a valve assembly adapted to regulate a communication between a tank and an inner volume of a tyre to bring said tank into communication with said tyre when pressure in said tyre is lower than an operating pressure, said mechanical valve assembly comprising a primary mechanical valve associated with at least one safety valve, wherein said safety valve is operatively interposed between a duct adapted to be connected to the inner volume of said tyre and a communication opening to be connected to the tank, to stop communication between said duct and said communication opening should a pressure value within the duct be lower than a pressure value in the communication opening.

Further features and advantages of the invention will become more apparent from the detailed description of some preferred but not exclusive embodiments of a wheel having a controlled and compensated pressure in accordance with the present invention.

This description will be set out hereinafter with reference to the accompanying drawings, given by way of non-limiting example, in which:

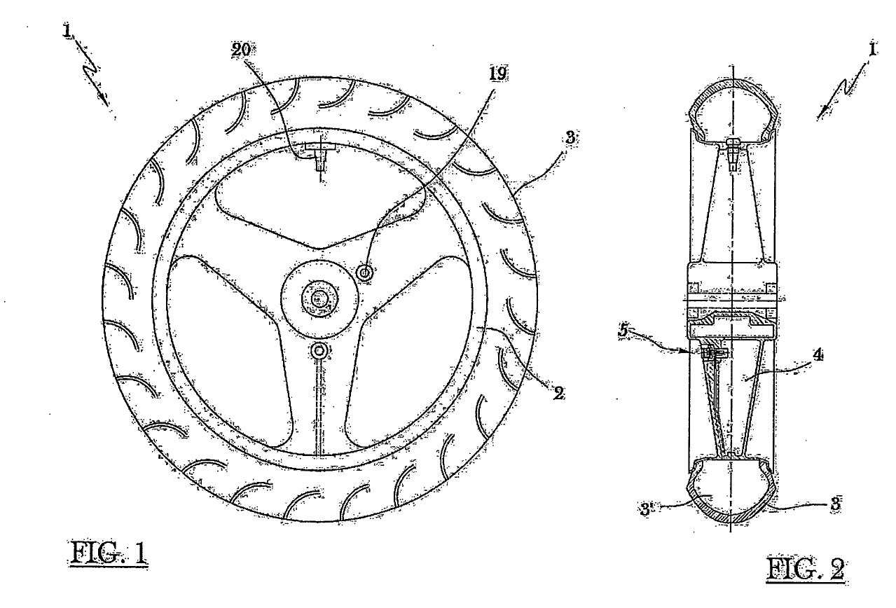

FIG. 1 is a vertical view of a wheel in accordance with the invention;

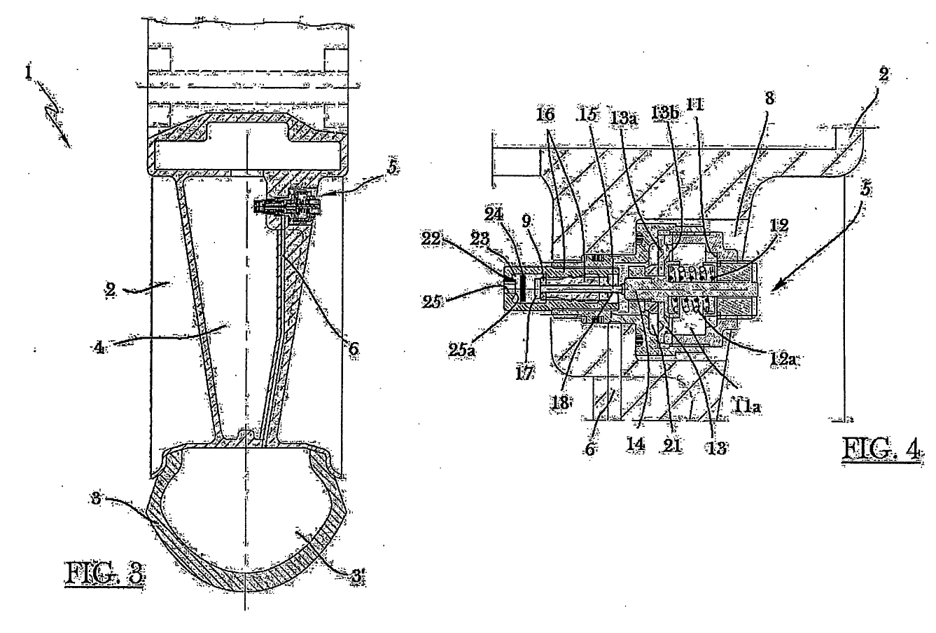

FIG. 2 is a side view partly in section of the wheel shown in FIG. 1;

FIG. 3 shows an enlarged portion of said side view;

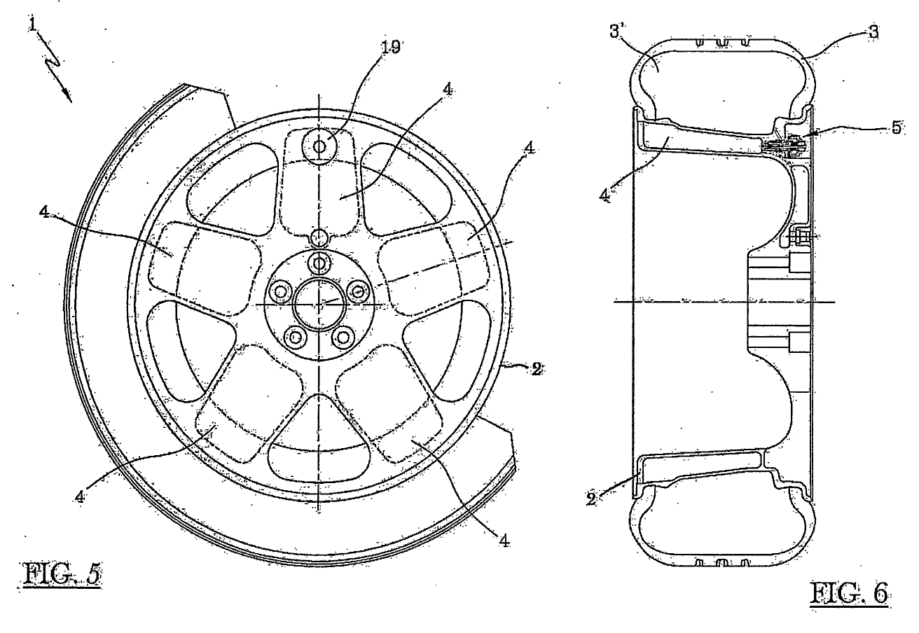

FIG. 4 is an enlarged section of a detail of the wheel in accordance with the invention;

FIG. 5 is a partial vertical view of a second embodiment of the wheel in accordance with the invention;

FIG. 6 is a side view partly in section of the wheel shown in FIG. 5;

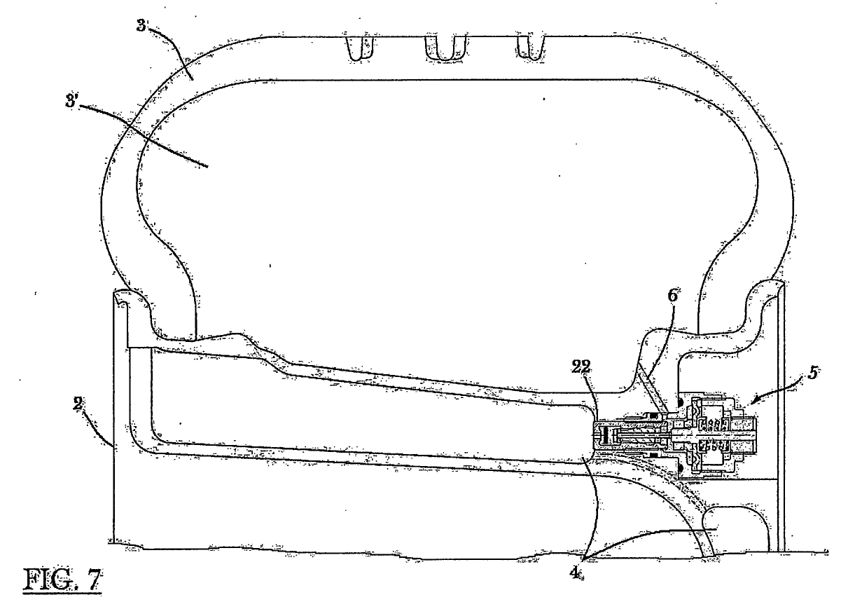

FIG. 7 shows an enlarged portion of the side view shown in FIG. 6;

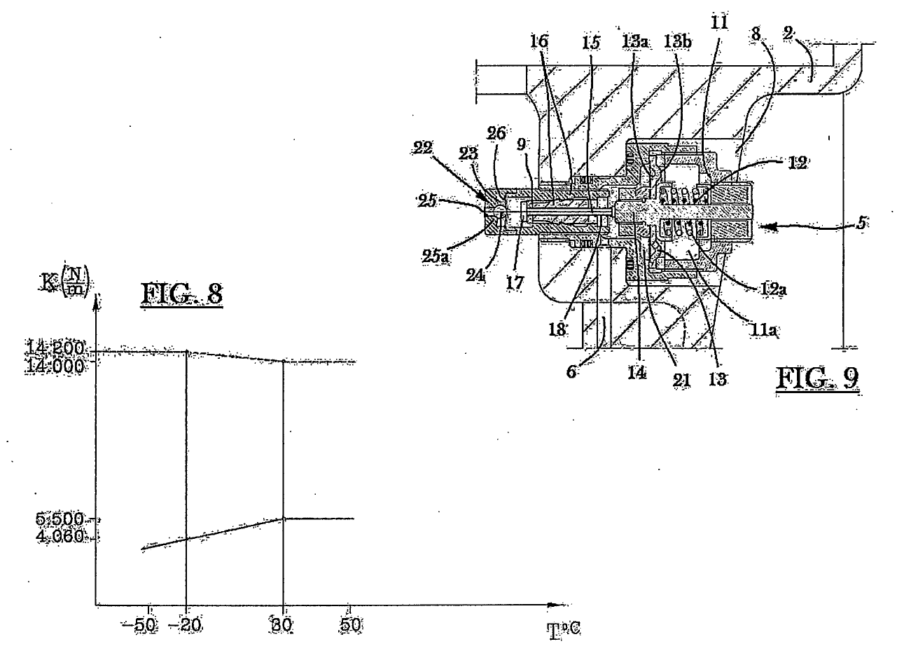

FIG. 8 is a graph showing the variation of an elastic constant of an element in said wheel upon varying of the temperature.

FIG. 9 schematically shows a detail of a preferred embodiment in accordance with the invention.

As shown in FIGS. 1, 2, 5 and 6, wheel 1 for two-wheeled vehicles (FIGS. 1, 2) or four-wheeled vehicles (FIGS. 5, 6) in accordance with the invention, comprises a rim 2 on which a tyre 3 of an inner volume 3′ is mounted. Provided in rim 2 is a tank 4 associated with said rim and preferably integrated into the latter, said tank being suitable to contain a fluid under pressure, said fluid being air or a substantially inert gas such as nitrogen, for example.

In accordance with a preferred embodiment, the ratio between the operating pressure of tyre 3 and a first pressure existing in said tank 4 when fully loaded varies between about 0.1 and about 0.6, preferably between about 0.2 and about 0.4.

According to a further preferred embodiment, the ratio between the volume of said tank 4 and said inner volume 3′ of the tyre is included between about 0.1 and about 0.4, preferably between about 0.12 and about 0.25.

The rim 2 preferably houses a primary mechanical valve 5 at a radially internal position not far from the rotation centre of the wheel, which valve allows communication between tank 4 and the inner volume 3′ of tyre 3 to be regulated.

Preferably, said communication is obtained by providing, within rim 2, a duct 6 connecting said primary valve 5 with the inner volume of said tyre 3, said primary valve 5 further providing a connection with said tank 4 either directly through a communication opening 25 and/or or through a further duct 6′ (FIG. 7).

Said primary valve 5 preferably comprises a valve body 7 housed in a suitable seat 8 formed in said rim 2, which valve body has a first port 9 for connection with said tank 4 and a second port 10 for connection with said tyre 3 and therefore preferably connected with said duct 6.

As shown in FIGS. 2, 3, 6 and 7, said valve body 7 is provided, internally of the axially external end, i.e. preferably at the opposite end of said first port 9, with a base disc 11 on which an elastic element rests, which elastic element preferably comprises at least one spring 12 housed in a space 11a.

Advantageously, said spring 12 is made of a material preferably selected from the so-called “shape memory alloy” (SMA) materials, in such a manner that its elastic constant K greatly depends on temperature.

For example, as shown in the graph in FIG. 8, it is possible to see that such dependence, in a graph Temperature (x axis)/Value of the elastic constant K (y axis) is substantially expressed by a straight line parallel to the x axis (chain line) for springs made of standard spring steel materials (i.e. the elastic constant is in this case substantially independent of temperature) within a predetermined temperature range, between −50° C. and +50° C. for example, which range, as better clarified in the following, can be coincident with the preferred temperature of use of wheel 1. Said dependence within said range is on the contrary expressed by an increasing or decreasing function for the springs 12 in accordance with the invention made of the above specified materials.

Preferably, in accordance with the invention, provision is made for use of materials having a temperature range in which the elastic constant K of the springs made with use of said materials greatly varies between about −50° C. and about +50° C., said range being preferably included between about −30° C. and about +50° C., and more preferably included between about −30° C. and about +20° C.

In particular, in the last-mentioned temperature range (−30° C./+20° C.) the value of this constant K varies by approximately 26% with respect to the value found at the upper end of the range (+20° C.) for a spring made of a nickel-titanium steel (diameter of the wire 1.2 mm, 2 useful coils), more specifically from about 5,500 N/m (at 20° C.) to about 4,060 N/m (at −30° C.).

The employed materials are in any case selected in such a manner that said variation is included between about 10% and about 40%, preferably between about 20% and about 30% in a predetermined temperature range, at least included between −50° C. and 50° C. or narrower.

More specifically, spring 12 controlling opening of the primary valve 5 has a value of the elastic constant measured at the lower end of said range (at −50° C. (K^{-50° C.}) for example) differing from the value of the elastic constant measured at the upper end of said range (at +50° C. (K^{+50° C.}) for example) by at least 10% and preferably by no more than 40%, with respect to the value of the elastic constant measured at the upper end of said range (at +50° C. (K^{+50° C.}) for example), that is to say:

$$Δ K = \frac{\vert {K}^{+ {50}^{∘} C .} - {K}^{- {50}^{∘} C .} \vert}{{K}^{+ {50}^{∘} C .}} * 100 \geq 10 \%$$

$$and$$

$$Δ K = \frac{\vert {K}^{+ {50}^{∘} C .} - {K}^{- {50}^{∘} C .} \vert}{{K}^{+ {50}^{∘} C .}} * 100 \leq 40 \%$$

According to said preferred solution, such dependence on temperature of the elastic constant is represented by a function increasing in said predetermined temperature range (FIG. 8).

Finally, in the same FIG. 8 it is possible to see that a spring made of a traditional spring steel, a UNI steel Class C for example, has a substantially constant value of the elastic constant K in the same temperature range (−30° C./+20° C.), said value being substantially equal to about 14,000 N/m at +20° C. and equal to about 14,200 N/m at −30° C., from which a variation ΔK equal to about 1.43% is drawn (diameter 1.2 mm, 3.5 useful coils).

In a preferred embodiment, as shown in FIG. 4, said elastic element 12, 12a comprises a second spring 12a operatively associated with spring 12. In particular, the second spring 12a is a spring made of traditional spring steel (e.g. UNI steel Class C), the spring 12 being made of shape memory alloy (SMA) materials as above explained. Therefore, the elastic constant K of the second spring 12a is substantially constant in a temperature range included between −50° C. and +50° C.

Preferably, springs 12 and 12a are concentrically coupled, so that the second spring 12a is external with respect to spring 12. Preferably, the load supported by said elastic element is divided between springs 12 and 12a in such a manner that the second spring 12a supports the major portion of said load. Consequently, valve 5 increases its sensitivity to temperature variation, because the spring 12 supports only a small load. Within this preferred embodiment and considering a Force/Elongation diagram, the load supported by spring 12 lies in a region of the diagram in which the curve is not asymptotic, i.e. a region in which the ratio between force and elongation is substantially linear. In a preferred embodiment, the load supported by said second spring 12a is included between about 60% and about 95% of the load supported by said elastic element, and more preferably between about 70% and about 80%.

As shown in FIGS. 2, 3, 4, 6 and 7, spring 12 is advantageously associated with a diaphragm 13 delimiting, by its axial position, the volume of a bag 21 communicating with said duct 6 and with the axially internal end of said valve body 7, i.e. the portion thereof close to the first port 9.

In more detail, the diaphragm 13 has a first surface 13a facing the bag 21 which is exposed to pressure of duct 6 and of the inner volume 3′ of tyre 3, and a second surface 13b which is exposed to a reference pressure present in the space 11a housing the springs 12, 12a and confined between the diaphragm itself and the base disc 11, which is hermetically insulated relative to tank 4. The space 11a can communicate with the external environment, in which case the reference pressure will correspond to the ambient pressure present externally of the wheel 1. Said diaphragm 13 is connected to a cap 14 extended in an axial direction, the other end of which can come into contact with a needle 15 housed in a bush 16 and terminating with a primary closure member 17 having an enlarged head, intervention of which allows passage of fluid through said first port 9 or not. Needle 15 is further maintained in place by another elastic element, such as a closing spring 18 for example.

To prevent any undesirable flowing back of fluid from tyre 3 to tank 4, at least one safety valve 22, preferably of the mechanical type, is advantageously provided, said valve being operatively interposed between the inner volume 3′ of the tyre and the tank itself.

The safety valve 22 preferably consists of a one-way on-off valve, advantageously integrated into the same valve body 7 housing the primary valve. In more detail, the safety valve 22 is preferably housed in one end of bush 16 axially facing tank 4, in which provision is made for a cavity 23 containing the primary closure member 17 belonging to the primary valve 5.

The safety valve 22 comprises a second closure member 24 housed in the holding cavity 23 as well and acting against an abutment seat defined by a perimetral edge 25a of a communication opening 25 connecting tank 4 to the inner volume 3′ of tyre 3 through the holding cavity 23 and port 9.

The second closure member 24 may comprise an elastic diaphragm acting in an abutment relationship against the perimetral edge 25a, as shown in FIG. 4. In a further preferred embodiment shown in FIG. 9, the second closure member 24 comprises a ball acting in abutment relationship with the perimetral edge 25a of the communication opening 25. A further spring or other auxiliary elastic element 26 can be housed in the holding cavity 23 to urge the second closure member 24 towards the perimetral edge 25a to close the communication opening 25.

Preferably, present on rim 2 is an inflation valve 19 directly in communication with tank 4, whereas in a further preferred embodiment a control and restoration valve 20 is provided that is in communication with the inner volume 3′ of tyre 3.

Pressure control and compensation within said wheel 1 take place as follows.

First, by a standard compressor for example, air is admitted into tank 4, preferably through the inflation valve 19 to a given room temperature, of 15, 20, 25° C. or other value for example, said temperature being here and in the following identified as reference temperature TR.

Initially tyre 3 is deflated, so that spring 12, preloaded to a given reference value in relation to the desired operating pressure within the tyre (that can generally vary from about 1.7 to about 5.5 bars, depending on the different tyre types), exerts pressure on the diaphragm 13 bringing cap 14 to act against needle 15, which action leads the closure member 17 to open the passage through port 9 thereby connecting tank 4 to bag 21 and therefrom to duct 6 and tyre 3.

When pressure within tyre 3 reaches the prescribed operating pressure, this pressure also exerts its action on the first surface 13a of diaphragm 13. The gradient between the inner pressure of tyre 3 acting against the first surface 13a of the diaphragm 13, and the ambient pressure or other reference pressure present in the space 11a and acting against the second surface 13b of the diaphragm itself, overcomes the spring 12 preload and causes separation of cap 14 from needle 15. The positioning spring 18 brings needle 15 back to the rest position dragging along the primary closure member 17 therewith to a closed position, thus inhibiting passage of fluid under pressure from tank 4 to bag 21. Then tank 4 is loaded to its rated capacity, generally included between 8 and 12 bars, more preferably between 8.5 and 10 bars.

During operation of the vehicle on which wheels 1 in accordance with the invention are mounted, small air losses occur due either to an imperfect airtightness of the radially inner layer of the tyre carcass structure, or to an imperfect adhesion between the tyre bead and the rim flange on which the bead bears, said pressure losses being quantifiable to about 0.1 bars/month. By reducing pressure in the inner volume 3′ of tyre 3, i.e. the pressure gradient between the inner tyre pressure and the ambient pressure or other reference value present in the space 11a, this reduction is transmitted to the bag 21 through duct 6. Consequently spring 12 acts against diaphragm 13 and moves the primary closure member 17 as above described to the open position, until pressure in the tyre, through bag 21 and therefore diaphragm 13, balances the force exerted by the calibration preload of spring 12.

Advantageously, the primary valve 5 is calibrated so that it begins operating only after the reduction in pressure within the inner volume 3′ has reached at least 5% of the operating pressure; in other words, taking into account what previously stated, such a reduction must preferably be included between about 0.085 and about 0.275 bars. In this way steadiness to the wheel assembly is ensured, small reloading operations being avoided when minimum pressure losses occur. This is due to the fact that, when the primary valve 5 is closed, pressure in tank 4 acts on the respective port 9 over the whole contact area of the closure member 17, while when the valve is open the action area of the same pressure corresponds to the only cross section of needle 15.

When the vehicle is not running and the external temperature decreases, due to the known gas laws the pressure within the tyre starts decreasing as well, of about 0.1 bar on an average every 10° C. of reduction with respect to the reference temperature TR. However, the elastic constant K of spring 12 advantageously depends on the temperature in the terms previously illustrated (in the example shown in FIG. 8 relating to a Ni/Ti steel, K decreases of about 5.24% every −10° C.), so that with a temperature reduction the constant too decreases, causing a reduction in the calibration preload as well. In this way the pressure reduction that is transferred to bag 21 from the inside of tyre 3 does not activate spring 12 because the spring preload is substantially decreased to such a value that it keeps balanced in spite of the reduced tyre pressure.

In this manner wheel 1 is not submitted to useless loading cycles due to possible high thermal ranges of the room temperature that would bring to a quick consumption of the fluid stored inside tank 4, which fluid would then be discharged when the tyre temperature approaches the reference temperature TR again, by means of valve 20, for example. Said valve 20 in a preferred embodiment is designed to avoid sudden overpressures, in case of failure of the primary valve 5 for example, and when it is necessary to control pressure within the inner volume 3′ of the tyre, also allowing the tyre inflation.

It is to be noted that the provided range in accordance with the invention within which said elastic constant varies substantially comprises the room temperature of normal operation of the tyre. This means that the concerned wheel 1 when it has to operate to such temperatures, has a temperature-compensated pressure control because the primary valve 5 does not start operation if the pressure reduction is only due to variations in the room temperature.

Also to higher temperatures with respect to the upper limit of said range an important variation in said elastic constant K does not occur but this fact is irrelevant as regards the correct operation of wheel 1. In fact, when it is hot (at temperatures higher than TR) the tyre is self-balancing, i.e. the higher pressure due to the high temperatures is used to support it under those operating conditions.

It is further to be noticed that still when it is hot, the higher pressure existing within tyre 3, being transferred into bag 21, further compresses spring 12, which spring avoids every reloading by increasingly moving away from cap 14.

In case of pressure loss from tank 4, following break or failure of the inflation valve 19, the primary valve 5 keeps in a closed position until a pressure reduction within tyre 3 occurs such as to cause displacement of the closure member 17 upon command of spring 12. In the absence of the safety valve 22 the consequent opening of port 9 for the purpose of achieving the desired restoration of the inner pressure of tyre 3, would on the contrary cause escape of the whole fluid present in the tyre itself towards tank 4, bringing about a consequent sudden deflation of same.

Advantageously, the safety valve 22 inhibits occurrence of the drawback described above. In fact, when the primary valve 5 opens in the absence of pressure or in the presence of an insufficient pressure within tank 4, the second closure member 24 is pushed against the corresponding abutment seat 25 by the pressure itself that is present in tyre 3, any flowing back of the fluid from the tyre to tank 4 being eliminated. Thus a safe running is ensured also in the absence of pressure in tank 4.

Finally it will be recognised that the inner arrangement of the elements of the primary valve 5 can be easily modified so as to have a closure member that is opened by effect of a pulling action of spring 12 and not of a thrusting action as previously illustrated. In this case the elastic constant K of the elastic element must increase on decreasing of the temperature in the previously mentioned temperature ranges, in order to obtain the same operation of said primary valve 5.

1-74. (canceled)

75. A method of controlling pressure in a vehicle wheel, wherein said wheel comprises a tyre mounted on a rim, comprising the steps of:
inflating an inner volume of the tyre to an operating pressure;
admitting a fluid compressed to a first pressure higher that the operating pressure of the tyre into a tank associated with the rim;
opening a fluid communication, by at least one primary mechanical valve between the inner volume of said tyre and said tank when pressure in the inner volume of said tyre is lower than said operating pressure;
stopping the communication between said inner volume and said tank when said pressure of the tyre is substantially equal to said operating pressure; and
stopping the communication between said inner volume and said tank when during said opening step by means of the primary valve, the pressure value within the tank is lower than the pressure value in the tyre.

76. The method as claimed in claim 75, wherein said step of stopping the communication between said inner volume and said tank, should the pressure value within the tank be lower than the pressure value in the tyre, is carried out by closing communication between the inner volume of said tyre and the tank by a mechanical safety valve.

77. The method as claimed in claim 76, wherein said safety valve is a one-way on-off valve.

78. The method as claimed in claim 75, wherein said opening step is controlled by an elastic element having an elastic constant varying on varying of temperature, so as to maintain said primary valve at a closed position following a reduction in the inner pressure of the tyre due to temperature reduction within a predetermined temperature range.

79. The method as claimed in claim 78, wherein said elastic constant of said elastic element varies within a temperature range between about −50° C. and about +50° C.

80. The method as claimed in claim 78, wherein said elastic element controlling opening of said primary valve has an elastic constant measured at −50° C. differing from the elastic constant measured at +50° C. by at least 10% with respect to the elastic constant measured at +50° C.

81. The method as claimed in claim 78, wherein said elastic element controlling opening of said primary valve has an elastic constant measured at −50° C. differing from the elastic constant measured at +50° C. by no more than 40% with respect to the elastic constant measured at +50° C.

82. The method as claimed in claim 75, wherein the ratio between said operating pressure of the tyre and said first pressure in said tank is between about 0.1 and about 0.6.

83. The method as claimed in claim 75, wherein the ratio between said operating pressure of the tyre and said first pressure in said tank is between about 0.2 and about 0.4.

84. The method as claimed in claim 75, wherein said first pressure in said tank is between about 8 bars and about 12 bars.

85. The method as claimed in claim 75, wherein said first pressure in said tank is between about 8.5 bars and about 10 bars.

86. The method as claimed in claim 75, wherein said step of opening the fluid communication is carried out in response to a pressure gradient reduction between the pressure of the tyre and a reference pressure present in an environment hermetically insulated from the tank.

87. The method as claimed in claim 75, wherein said step of opening the fluid communication between the inner volume of said tyre and said tank is carried out when the pressure of said tyre is lower than said operating pressure by at least 5%.

88. The method as claimed in claim 78, wherein said elastic constant decreases on decreasing of the temperature.

89. The method as claimed in claim 78, wherein said elastic constant increases on decreasing of the temperature.

90. A wheel having a controlled pressure, comprising:
a rim associated with a tank adapted to be filled with a fluid to a first pressure;
a tyre mounted on said rim and having an inner volume inflatable to an operating pressure, said operating pressure being lower than said first pressure;
at least one primary mechanical valve adapted to regulate communication between said tank and the inner volume of said tyre to bring said tank into communication with said tyre when the pressure of said tyre is lower than said operating pressure; and
at least one safety valve operatively interposed between the inner volume of the tyre and the tank to stop the communication between said inner volume and said tank should the pressure value within the tank be lower than the pressure value of the tyre.

91. The wheel as claimed in claim 90, wherein said safety valve is a mechanical valve.

92. The wheel as claimed in claim 90, wherein said safety valve is a one-way on-off valve.

93. The wheel as claimed in claim 90, wherein said safety valve comprises a second closure member acting against an abutment seat defined by a perimetral edge of a communication opening between the tank and the inner volume of the tyre.

94. The wheel as claimed in claim 93, wherein said second closure member comprises an elastic diaphragm acting in abutment relationship with said abutment seat.

95. The wheel as claimed in claim 93, wherein said second closure member comprises a ball acting in abutment relationship with said abutment seat.

96. The wheel as claimed in claim 95, wherein said safety valve further comprises an auxiliary elastic element to push said second closure member toward said abutment seat.

97. The wheel as claimed in claim 90, wherein said safety valve is integrated into a valve body of said primary valve.

98. The wheel as claimed in claim 90, wherein said primary valve comprises at least one elastic element operatively associated with at least one primary closure member designed to open and close a port of said primary valve.

99. The wheel as claimed in claim 98, wherein said elastic element has an elastic constant varying in such a manner as to maintain the primary valve in a closed position following a reduction in inner pressure of the tyre due to a temperature reduction within a predetermined range.

100. The wheel as claimed in claim 99, wherein the elastic constant of said elastic element varies within a temperature range between about −50° C. and about +50° C.

101. The wheel as claimed in claim 99, wherein said elastic element controlling opening of said port has an elastic constant measured at −50° C. differing from the elastic constant measured at +50° C. by at least 10% with respect to the elastic constant measured at +50° C.

102. The wheel as claimed in claim 99, wherein said elastic element controlling opening of said port has an elastic constant measured at −50° C. differing from the elastic constant measured at +50° C. by no more than 40% with respect to the elastic constant measured at +50° C.

103. The wheel as claimed in claim 98, wherein said elastic element comprises one spring.

104. The wheel as claimed in claim 103, wherein said elastic element comprises a second spring operatively associated with said spring.

105. The wheel as claimed in claim 104, wherein said second spring has an elastic constant substantially constant within a temperature range of −50° C. to +50° C.

106. The wheel as claimed in claim 105, wherein said second spring supports a major portion of a load of said elastic element.

107. The wheel as claimed in claim 106, wherein the load supported by the second spring is between about 60% and about 95% of the load supported by said elastic element.

108. The wheel as claimed in claim 106, wherein the load supported by the second spring is between about 70% and about 80% of the load supported by said elastic element.

109. The wheel as claimed in claim 104, wherein the second spring is concentrically coupled to said one spring.

110. The wheel as claimed in claim 109, wherein the second spring is external with respect to said one spring.

111. The wheel as claimed in claim 90, wherein said tank is integrated in said rim.

112. The wheel as claimed in claim 90 wherein said tank comprises a volume such that the ratio between said volume of said tank and said inner volume of the tyre is between about 0.1 and about 0.4.

113. The wheel as claimed in claim 112, wherein said ratio is between about 0.12 and about 0.25.

114. The wheel as claimed in claim 98, wherein said elastic constant decreases on decreasing of the temperature within said temperature range.

115. The wheel as claimed in claim 98, wherein said elastic constant increases on decreasing of the temperature within said temperature range.

116. The wheel as claimed in claim 98, wherein said primary closure member comprises a diaphragm having a first surface exposed to the pressure of the inner volume of the tyre, and a second surface exposed to a reference pressure present in an environment hermetically insulated from the tank.

117. The wheel as claimed in claim 116, wherein the second surface of the diaphragm is exposed to an ambient pressure present externally of the wheel.

118. The wheel as claimed in claim 116, wherein the primary closure member is movable relative to the port of the primary valve in response to a reduction in a pressure gradient between pressure of the tyre and the reference pressure.

119. The wheel as claimed in claim 98, wherein said primary valve brings said tyre into communication with said tank when the pressure in said tyre is lower than said operating pressure by at least 5%.

120. The wheel as claimed in claim 90, wherein said wheel comprises an inflating valve operatively associated with said tank.

121. The wheel as claimed in claim 90, wherein said wheel comprises a control and restoration valve associated with said tyre.

122. A mechanical valve assembly adapted to regulate communication between a tank and an inner volume of a tyre to bring said tank into communication with said tyre when pressure in said tyre is lower than an operating pressure, comprising: a primary mechanical valve associated with at least one safety valve, wherein said safety valve is operatively interposed between a duct adapted to be connected to the inner volume of said tyre and a communication opening to be connected to the tank, to stop communication between said duct and said communication opening should a pressure value within the duct be lower than a pressure value in the communication opening.

123. The valve assembly as claimed in claim 122, wherein said safety valve is a mechanical valve.

124. The valve assembly as claimed in claim 122, wherein said safety valve is a one-way on-off valve.

125. The valve assembly as claimed in claim 122, wherein said safety valve comprises a second closure member acting against an abutment seat defined by a perimetral edge of a communication opening between the tank and the inner volume of the tyre.

126. The valve assembly as claimed in claim 125, wherein said second closure member comprises an elastic diaphragm acting in abutment relationship with said abutment seat.

127. The valve assembly as claimed in claim 125, wherein said second closure member comprises a ball acting in abutment relationship with said abutment seat.

128. The valve assembly as claimed in claim 125, wherein said safety valve further comprises an auxiliary elastic element to push said second closure member toward said abutment seat.

129. The valve assembly as claimed in claim 125, wherein said safety valve is integrated into a valve body of said primary mechanical valve.

130. The valve assembly as claimed in claim 125, wherein said primary mechanical valve comprises at least one elastic element operatively associated with at least one primary closure member designed to open and close at least one port of said primary mechanical valve.

131. The valve assembly as claimed in claim 130, wherein said elastic element has an elastic constant varying in such a manner as to maintain the primary mechanical valve to a closed position following a pressure reduction in said duct due to a temperature reduction within a predetermined range.

132. The valve assembly as claimed in claim 131, wherein the elastic constant of said elastic element varies within a temperature range between about −50° C. and about +50° C.

133. The valve assembly as claimed in claim 131, wherein said elastic element controlling opening of said port has an elastic constant measured at −50° C. differing from the elastic constant measured at +50° C. by at least 10% with respect to the elastic constant measured at +50° C.

134. The valve assembly as claimed in claim 131, wherein said elastic element controlling opening of said port has an elastic constant measured at −50° C. differing from the elastic constant measured at +50° C. by no more than 40% with respect to the elastic constant measured at +50° C.

135. The valve assembly as claimed in claim 130, wherein said elastic element comprises one spring.

136. The valve assembly as claimed in claim 135, wherein said elastic element comprises a second spring operatively associated with said one spring.

137. The valve assembly as claimed in claim 136, wherein said second spring has an elastic constant substantially constant within a temperature range of −50° C. to +50° C.

138. The valve assembly as claimed in claim 137, wherein said second spring supports a major portion of load of said elastic element.

139. The valve assembly as claimed in claim 138, wherein the load supported by the second spring is between about 60% and about 95% of the load supported by said elastic element.

140. The valve assembly as claimed in claim 138, wherein the load supported by the second spring is between about 70% and about 80% of the load supported by said elastic element.

141. The valve assembly as claimed in claim 136, wherein the second spring is concentrically coupled to said one spring.

142. The valve assembly as claimed in claim 141, wherein the second spring is external with respect to said one spring.

143. The valve assembly as claimed in claim 131, wherein said elastic constant decreases on decreasing of the temperature in said temperature range.

144. The valve assembly as claimed in claim 131, wherein said elastic constant increases on decreasing of the temperature in said temperature range.

145. The valve assembly as claimed in claim 130, wherein said primary closure member comprises a diaphragm having a first surface adapted to be exposed to the pressure of the duct, and a second surface exposed to a reference pressure present in an environment hermetically insulated from said communication opening.

146. The valve assembly as claimed in claim 145, wherein the second surface of the diaphragm is exposed to an ambient pressure present externally of the valve assembly.

147. The valve assembly as claimed in claim 145, wherein the primary closure member is movable relative to the port of the primary valve in response to a reduction in a pressure gradient between the pressure acting against said first surface and against said second surface of the diaphragm, respectively.

148. The valve assembly as claimed in claim 130, wherein said primary valve brings said duct into communication with said communication opening when the pressure in the duct is lower than said operating pressure by at least 5%.
